(19) United States
(12) Patent Application Publication
(10) Pub. No.: US 2008/0236846 A1
(43) Pub. Date: Oct. 2, 2008

(54) Stationary fire fighting foam system and method

(76) Inventors: Jonathan Gamble, Taylors Falls, MN (US); William Ballantyne, Eden Prairie, MN (US)

Correspondence Address: GREENBERG TRAURIG (PHX), INTELLECTUAL PROPERTY DEPARTMENT, 2450 COLORADO AVENUE , SUITE 400E, SANTA MONICA, CA, 90404, US

(21) Appl. No.: 12/077,982

(22) Filed: Mar. 24, 2008

Related U.S. Application Data
(60) Provisional application No. 60/919,959, filed on Mar. 23, 2007.

(51) Int. Cl. A62C 35/68; A62C 37/00

(52) U.S. Cl. 169/15; 169/13; 169/37; 137/552; 137/559

(57) ABSTRACT

Embodiments of the invention provide a stationary fire fighting system for retrofitting into a structure. The system can include a flowmeter in fluid communication with a water line in the structure. The flowmeter can generate a flow rate signal. The system can include a controller connected to the flowmeter and a proportioner pump connected to the controller. The system can include an additive supply tank in fluid communication with the proportioner pump. The controller can operate the proportioner pump based on the flow rate signal to provide additive from the additive supply tank to the water line to create a solution. The system can include at least one sprinkler head to distribute the solution within the structure.

### BACKGROUND

Retrofitting sprinkler systems into older structures is a significant cost, to the point where, in some cases, it is more economical to tear down the structure and start over. Fire fighting systems can use solutions of an additive that helps fight fires, such as foam concentrate, mixed with water. The foam solutions are prepared by proportioning the foam concentrate into the water. Class A foams are well suited for a wide array of ordinary combustibles (i.e., Class A fuels such as wood, paper, cloth, grass, etc.) found in a typical urban housing or commercial office setting. The effectiveness of Class A foam primarily depends on the amount of water brought into contact with the fuel/fire interface for insulating and/or cooling. Aqueous solutions that contain low concentrations of foam additive exhibit surface tensions less than that of water alone. This reduction in surface tension improves the penetrating capability of the foam solution, allowing a greater amount of the applied foam solution to be captured and absorbed by porous fuels.

### SUMMARY

In some embodiments, the invention provides a stationary fire fighting system for retrofitting into a structure, such as an existing building or a new building, or as an addition to an existing sprinkler system. The system can include a flowmeter in fluid communication with a water line in the structure. The flowmeter can generate a flow rate signal. The system can include a controller connected to the flowmeter and a proportioner pump connected to the controller. The system can include an additive supply tank in fluid communication with the proportioner pump. The controller can operate the proportioner pump based on the flow rate signal to provide additive from the additive supply tank to the water line to create an additive solution. The system can include at least one sprinkler head to distribute the additive solution within the structure.

Other aspects of the invention will become apparent by consideration of the detailed description and accompanying drawings.

### BRIEF DESCRIPTION OF THE DRAWINGS

FIG. 1 is a schematic diagram of a fire fighting system according to one embodiment of the invention.

FIG. 2 is another schematic diagram of the fire fighting system of FIG. 1.

FIG. 3 is a perspective view of a case for portions of the fire fighting system of FIG. 1.

FIG. 4 is a flowchart illustrating closed loop control for use with the fire fighting system of FIG. 1.

FIGS. 5A-5E are graphs comparing water, foam, and compressed air foam solution (CAFS) fire suppression capabilities.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

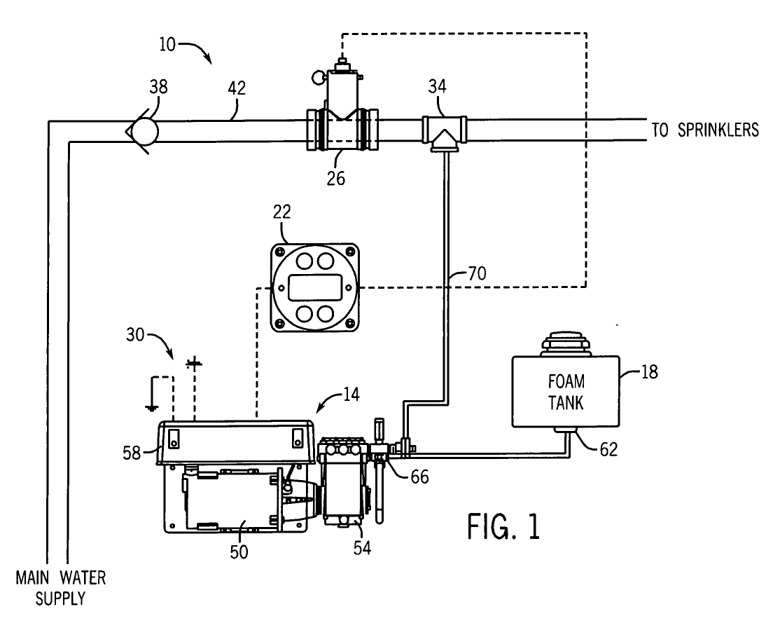

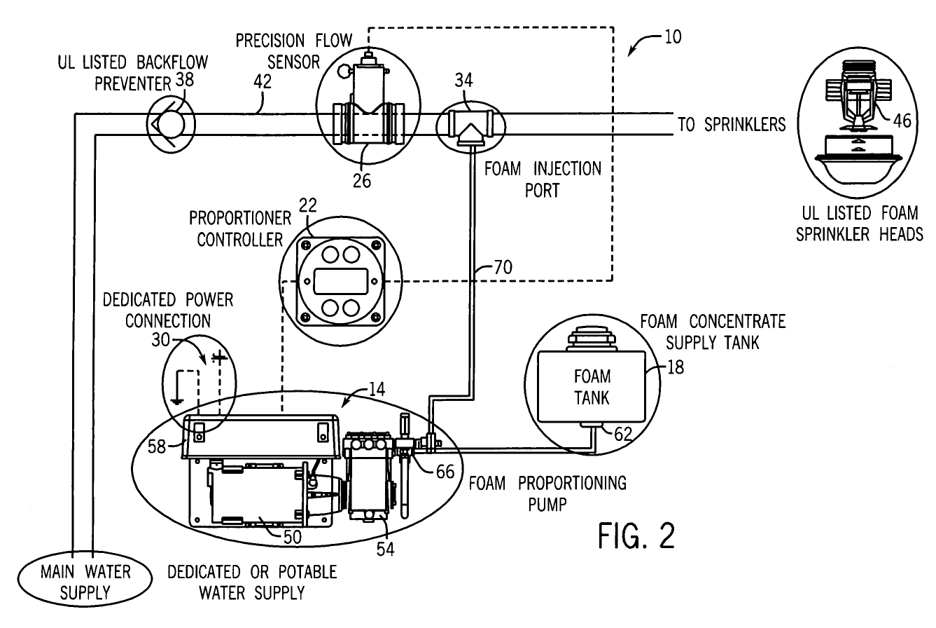

FIGS. 1 and 2 illustrate one embodiment of a fire fighting system 10 suitable to be retrofit into a structure, such as a residential, commercial, or industrial building, complex, or high-rise. The system 10 can mix water and an additive that helps to fight fires, such as foam concentrate, in order to create an aqueous fire suppressive solution. The system 10 can be connected to an isolated or dedicated water supply (e.g., a water storage tank, etc.) or to an existing or potable water supply (e.g., a city water main, a well, a lake, etc.). The water supply can deliver water to the system 10 at a pressure between about 7 psi and about 500 psi or more. In some embodiments, the water supply can deliver water to the system 10 at a pressure between about 15 and about 120 pounds per square inch (psi). Other embodiments of the invention can operate over other suitable pressure ranges.

The additive, such as foam concentrate, can be in the form of a liquid, gas, powder, or solid. In some embodiments, the system 10 can be configured for use with Class A foam concentrate capable of suppressing Class A fires. Class A fires include fires involving ordinary combustible, such as, for example, paper, wood, cloth, grass, etc. Additionally or alternatively, the system 10 can be configured for use with Class B foam concentrate capable of suppressing Class B fires (i.e., fires involving flammable liquids), as well as other types of foam concentrates. In general, the system 10 can be compatible with Class A, Class B, and other types of foam concentrate. Also, rather than foam concentrate, the system 10 can be compatible with other types of additives that help fight fires. In addition, the system 10 can be configured to comply with the following standards: NFPA 1145, NFPA 1150, NFPA 13, NFPA 13D, NFPA 13E, NFPA 13R, UL 162, UL 199, UL 1626, FM 2030, as well as other fire suppression foam equipment standards.

As shown in FIGS. 1 and 2, the system 10 can include a proportioner pump 14, an additive supply tank 18, a display controller 22, a flowmeter 26, a power connection 30, an injection port 34, and a backflow preventer 38. The system 10 receives water through a water line 42, mixes additive with the water near the injection port 34, and ejects the solution from sprinklers onto a fire. As shown in FIG. 2, the solution can be delivered through a sprinkler head 46. In one embodiment, the system 10 can deliver between about 0.01 gallons per minute (gpm) and 2.6 gpm of foam concentrate. In another embodiment, the system 10 can deliver between about 2.0 gpm and about 150 gpm of foam concentrate. Other embodiments of the invention can accommodate higher or lower foam concentrate flow rates. In some embodiments, the system 10 can proportion the water and the additive between about minus zero of a preset value (i.e., never below the preset value) and about +5% of the preset value (i.e., never more than about 5% greater than the preset value).

In some embodiments, the proportioner pump 14 can be an electronic, fully automatic, variable speed, direct injection, discharge side proportioning system. The proportioner pump 14 can include an electric motor 50, a positive displacement pump 54, and a pump motor electronic driver 58. The electric motor 50 can be a 1/2 horsepower (hp) motor coupled to the positive displacement pump 54. In some embodiments, the positive displacement pump 54 can operate at up to about 2.5 gpm at about 150 psi. In some embodiments, the positive displacement pump 54 can operate at up to about 400 psi. In some embodiments, the electric pump 50 can include a self-test capability. The electronic driver 58 can be mounted to a base of the pump 14 and can receive signals from the display controller 22 to control the electric motor 50. The electronic driver 58 can use a variable speed duty cycle (e.g., pulse width modulation) or closed-loop DC servo control to ensure that the correct proportion of additive preset by an operator is injected into the water stream. In addition, pulse width modulation or closed-loop DC servo control can facilitate low end (i.e., low flow) performance of the electric motor 50. Other closed-loop control systems can also be used. In other embodiments, the proportioner pump 14 can be replaced or supplemented by a balanced pressure system, a high pressure mist system, a foam eductor, a water powered pump, a pressurized pump (e.g., a mechanical pressure generating, device such as a spring or weight), or a water intensifier system.

The additive supply tank 18 can be configured to receive and store the additive, such as foam concentrate (e.g., Class A or Class B foam concentrate, etc.). In some embodiments, the additive supply tank 18 is positioned so that an outlet 62 of the additive supply tank 18 is higher than an inlet 66 of the proportioner pump 14 to facilitate flow of the additive to the proportioner pump 14. In some embodiments, the additive supply tank 18 can include an electronic low level sensor to indicate when only about 10% of the additive remains in the additive supply tank 18. In some embodiments, the additive supply tank 18 can include an actual level sensor to indicate the actual level of additive in the additive supply tank 18. Additionally or alternatively, the additive supply tank 18 can include a site glass or can be constructed of a transparent material (e.g., glass, clear plastic, etc.) so that a user can visually inspect the relative fill level of the additive supply tank 18.

The additive supply tank 18 can be sized appropriately based on water and additive flow rates to supply additive for a predetermined amount of time. For example, in a system configured to supply a foam mixture to four sprinkler heads 46, the additive supply tank 18 can be sized to contain enough foam concentrate so that all four sprinkler heads 46 can spray the foam solution for about 20 minutes. In some embodiments, to facilitate proper flow, the foam viscosity does not exceed about 100 centipoise (cps).

In some embodiments, the display controller 22 can be a digital electronic display suitable for installation on a panel of the proportioner pump 14. Additionally or alternatively, the display controller 22 can be configured for use with wiring harnesses or a wireless communication network to facilitate installation away from the proportioner pump 14. The display controller 22 can include a microprocessor that receives input from the flowmeter 26 and the tank level sensor, while also monitoring additive output. The display controller 22 compares these and other values to ensure that the preset proportional amount of additive is injected into the water line 42.

In some embodiments, the display controller 22 can be configured to display or perform one or more of the following operations: display the current flow-per-minute of water; display the total volume of water discharged during and after operations are completed; display the total amount of additive consumed; display the total amount of additive remaining; simulate flow rates for manual operation and/or remote testing; perform setup, calibration, and diagnostic functions for installation and testing; display and report a “low concentrate” warning when the additive supply tank 18 runs low; display and report a “no concentrate” warning and shut the positive displacement pump 54 off, preventing damage to the pump 54 should the additive supply tank 18 become empty; display and report a “power fault” when the system 10 loses an electrical power connection; and/or display and report a “test fault” when the system 10 fails any self diagnostic tests. In some embodiments, some information from the display controller 22, such as the additive level, the additive flow rate, the water flow rate, the operating mode, and the power supply status, can be remotely readable over a suitable network.

The flowmeter 26 can be a paddlewheel-type flow sensor connected to the display controller 22. In some embodiments, the flowmeter 26 is positioned on the water line 42 upstream of the injection port 34 to measure the water flow. In some embodiments, the flowmeter 26 can measure the water flow over a range of about 1 to about 30 feet per second with an accuracy of about 1%. In some embodiments, an additional flowmeter can be installed in a sprinkler or discharge of the system 10 to monitor the water/additive solution flow rate.

The power connection 30 can connect the system 10 to a dedicated circuit capable of providing AC or DC power, such as 120 VAC power. In one embodiment, the maximum power used by the system 10 can be less than about 1200 Watts and 10 amps in an active state (i.e., running or operating state), and less than about 24 Watts and 200 milliamps in the quiescent state (i.e., non-operating state).

In some embodiments, the system 10 can include a supplemental battery backup or uninterruptible power supply (UPS) system. The backup power supply can provide reliability and redundancy in case of a power failure. Operating limits of the proportioner pump 14 can be constrained by the capacity of the battery backup or UPS system.

As shown in FIGS. 1 and 2, the injection port 34 is positioned downstream of the flowmeter 26 and couples a discharge line 70 of the proportioner pump 14 with the water line 42. The injection port 34 can be, for example, a female ½ inch NPT T-coupler, with other couplers also being suitable for use. The injection port 34 can allow additive from the proportioner pump 14 to enter the water line 42 and mix with the water. In some embodiments, the injection port 34 can be configured to withstand pressures up to about 125 psi.

The backflow preventer 38 can be positioned upstream of the injection port 34 and the flowmeter 26. The backflow preventer 38 can be, for example, a UL listed backflow preventer meeting the NFPA 13 standard. The backflow preventer 38 can inhibit water and/or additive from flowing back toward the water supply.

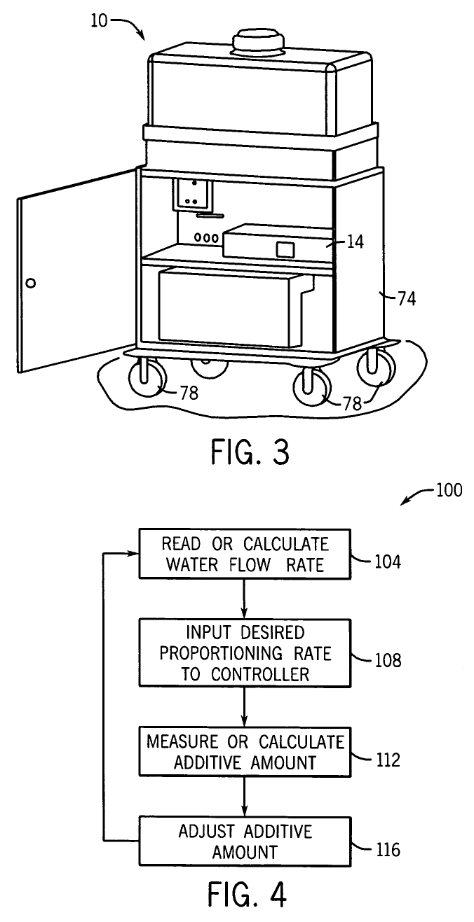

FIG. 3 illustrates a case 74 configured to hold and store several components of the system 10. The case 74 can hold the proportioner pump 14, the display controller 22, and the additive supply tank 18 to allow easy accessibility during installation and/or maintenance of the system 10. To fit within the case 74, the proportioner pump 14 can have dimensions less than about a 24 inch cube and can weigh less than about 100 pounds. In addition, the additive supply tank 18 can be positioned on top of the case 74 so that the supply tank 18 can be easily refilled. In some embodiments, the case 74 can include caster wheels 78 to facilitate movement of the case 74 into and within the building that is being retrofit.

As shown in FIG. 2, the system 10 can be configured for use with the sprinklers 46 located downstream of the injection port 34. The system 10 can be configured for use with one to four or more sprinklers 46. In some embodiments, the sprinkler 46 can be, for example, a UL listed sprinkler head. In other embodiments, the system 10 can be configured for use with compressed air foam sprinkler heads, mist sprinkler heads, or other suitable sprinklers.

In some embodiments, the system 10 can include a fire panel communication system (not shown). The fire panel communication system can be capable of reporting any status, warning, fault conditions, and service dates from the display controller 22 to a remote location (e.g., a security system company, a 911 dispatcher, a fire call box, or a monitoring company) via a wired, wireless (e.g., by a IEEE 802.15.4, ZigBee™, or MIWI™ protocol), or phone network. The communication system can be linked to existing fire panels or remote notification stations to alert an operator should the system 10 become activated or fail a self diagnostic test. In some embodiments, the fire panel communication system can allow for remote testing, calibration, and/or control of the system 10. In some embodiments, linking the system 10 to an outside location allows historical data of the system 10 to be transmitted and/or stored for later reference.

In operation, water flows from the water supply through the water line 42 toward the system 10. Water flow can be triggered automatically by detection of a fire or manually during testing, calibration, or preemptive detection of a fire. Once the water begins to flow through the water line 42, the system 10 can automatically begin injecting additive, such as foam concentrate, from the additive supply tank 18 into the water line 42. For example, the system 10 can automatically detect water flow by actuation of the flowmeter 26 or through a secondary sensor. To inject the additive, the proportioner pump 14 draws the additive from the additive supply tank 18 and pushes the additive toward the injection port 34 according to a preset amount stored in the display controller 22. If the additive demand exceeds the proportioner pump 14 capacity, the proportioner pump 14 can deliver additive at its max rated capacity. Since the proportioner pump 14 is not drawing water from the water line 42, the water flow and pressure to the sprinkler heads 46 are not affected by the system 10 regardless of the operating status.

When the additive is injected through the injection port 34, the water and the additive mix to create an aqueous fire suppression solution. The solution is pushed through the water line 42 and discharged through the sprinkler heads 46. Discharging the solution spreads the solution over the surrounding environment, suppressing fire within range of the sprinkler heads 46 and inhibiting further fire formations. If the system 10 uses up all of the additive before completely suppressing the fire or shut-down of the system 10, the system 10 can continue to operate with only water.

FIG. 4 is a flowchart of closed loop control 100 performed by the display controller 22 in order to monitor and manage the system 10. The operation of the closed loop control 100 is based on a direct measurement of the water flow and remains consistent with specified flows and pressures.

The display controller 22 reads or calculates (at 104) the flow of water through the water line 42 with the flowmeter 26. In some embodiments, the system 10 can include an aspirator or Venturi pump to help control the flow of water. A user can input (at 108) a desired proportioning rate (i.e., water to foam concentrate ratio) into the display controller 22. The desired proportioning rate can be preset during installation or before activation of the system 10. In some embodiments, multiple additive supply tanks 18 with different types of additive can be used, and a user can choose which type of additive to use for the current environment. A suitable amount of additive (e.g., foam concentrate) can be measured or calculated (at 112) to correspond to the desired proportioning rate. Depending on the type of additive (e.g., liquid, polymer, solid, gas), the amount of additive can be measured or calculated by monitoring the flow rate, volume, mass, conductivity, etc. of the additive. The display controller 22 can use the closed loop control 100 to adjust (at 116) the amount of additive injected into the system 10 based on the flow rate of the water. The amount of additive injected can be controlled by adjusting valve positions, pump speeds or pressures, etc. As the flow rate of the water changes, the display controller 22 can use the closed loop control 100 to adjust the calculations and injection amounts of additive so that the proportioning rate remains constant.

The system 10 can be calibrated and tested without an actual fire. Calibration and testing help ensure that the system 10 is ready and suitable for use in the event of a fire. In addition, calibration and testing of the system 10 can be performed with or without injecting additive and with or without water flowing through the water line 42 and the sprinkler heads 46.

Compressed gas can be stored in tanks 124, 128 so that the system 120 delivers a solution driven by compressed gas, such as compressed air foam solution (CAFS), for fire suppression. Rather than air, other gases can be used, such as a suitable inert gas (e.g., nitrogen). In some embodiments, the compressed air tanks 124, 128 can be bladder tanks with compressed air cylinders. In some embodiments, the system 120 can include a compressor so that the gas is compressed on-demand, rather than being stored in a tank. The first tank 124 can be positioned to mix compressed air with the foam concentrate before the foam concentrate is injected into the water line 42. A valve 132 positioned between the first tank 124 and the additive supply tank 18 can be actuated by the display controller 22 to control when the compressed gas is mixed with the additive. The compressed gas can also be used as the driving force to inject the additive into the water line 42, replacing the function of the proportioner pump 14. The second tank 128 can be positioned to mix additional compressed gas with the solution after the additive has entered the water line 42, but before the solution is discharged through the sprinklers 46. An additive control valve 136 and a compressed gas control valve 140 can be actuated by the display controller 22 to regulate the amount of additive and compressed gas being injected into the water line 42.

The system 120 can also include an additive flow meter 144 to measure the flow rate of the additive, an air flow meter 148 to measure the flow rate of the compressed gas leaving the second tank 128, and check valves 152 to inhibit additive, compressed gas, and/or water from flowing back into the additive supply tank 18 or compressed gas tanks 124, 128.

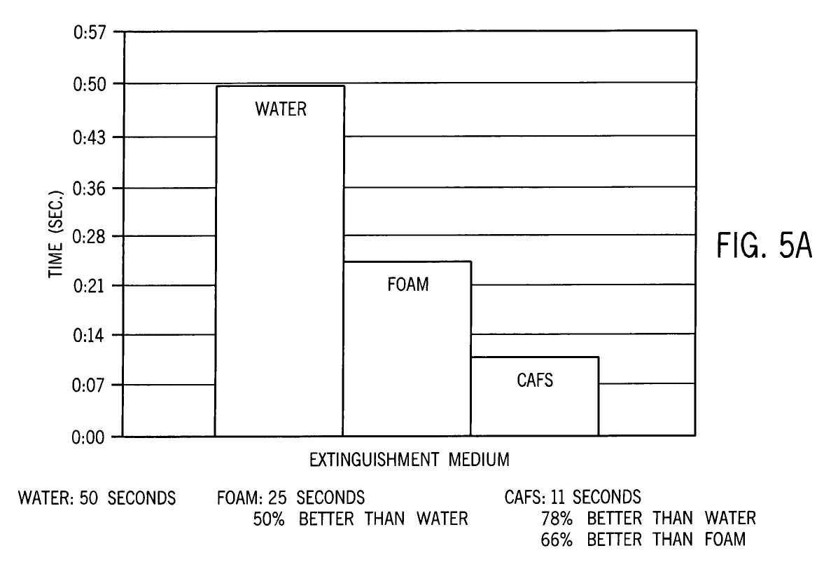

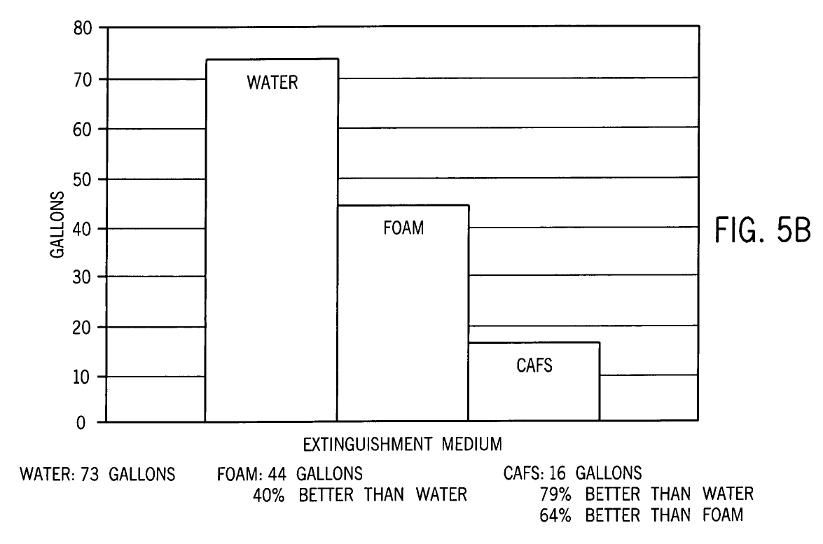

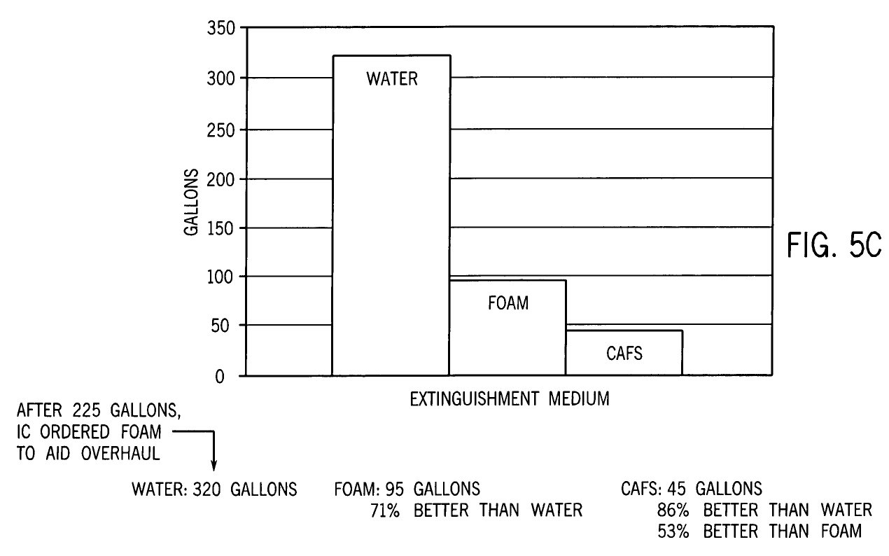

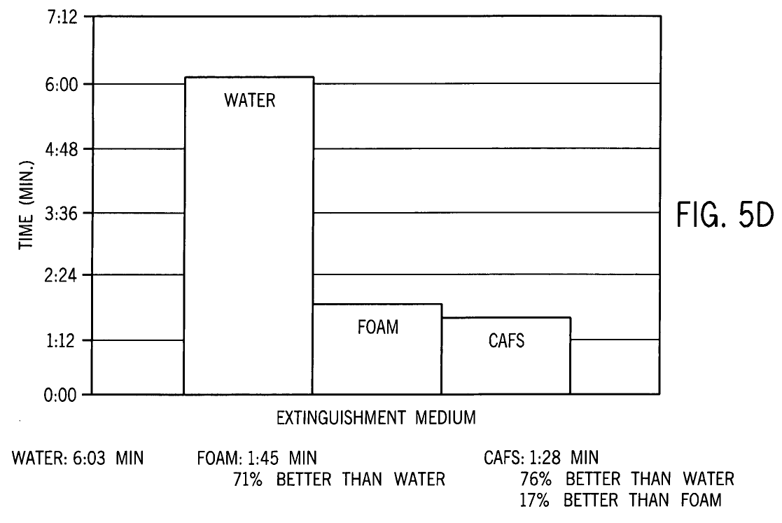

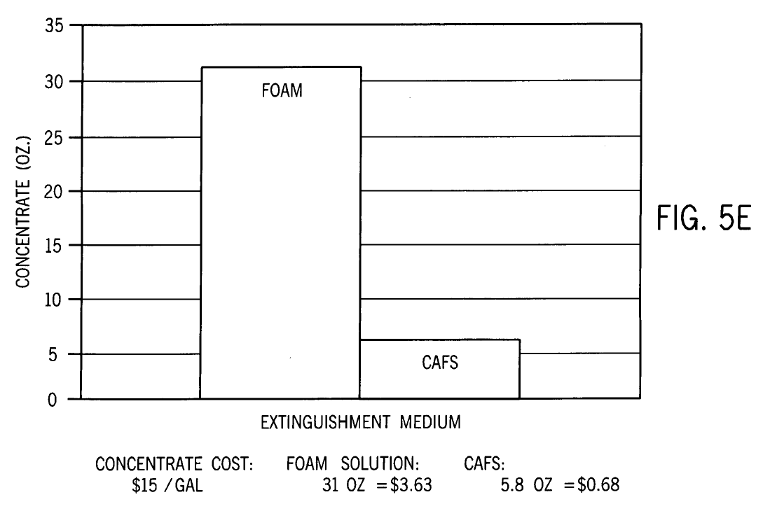

FIGS. 5A-5E are graphs comparing fire suppression characteristics with different extinguishments mediums. In the graphs, the extinguishment mediums are water, foam (i.e., naturally aspirated foam), and CAFS. FIG. 5A illustrates the time it takes the extinguishment mediums to knockdown a fire. FIG. 5B illustrates the gallons of extinguishment medium required to knockdown a fire. FIG. 5C illustrates the total gallons of extinguishment medium required to completely suppress a fire. FIG. 5D illustrates the time to cool a fire from 600 degrees Fahrenheit to 200 degrees Fahrenheit with the extinguishment mediums. FIG. 5E illustrates the amount of foam concentrate used to suppress a fire and the total cost of foam concentrate using the extinguishment mediums. In general, the graphs demonstrate superior fire suppression capability of foam over plain water when operated at equal flow rates.

Various features and advantages of the invention are set forth in the following claims.

1. A stationary fire fighting system for retrofitting into a structure, the structure including a water supply and a water line, the system comprising:
a flowmeter in fluid communication with the water line, the flowmeter generating a flow rate signal;
a controller connected to the flowmeter;
a proportioner pump connected to the controller;
an additive supply tank in fluid communication with the proportioner pump, the controller operating the proportioner pump based on the flow rate signal to provide additive from the additive supply tank to the water line to create a solution; and
at least one sprinkler head to distribute the solution within the structure.

2. The system of claim 1 wherein the additive is at least one of a Class A foam concentrate and a Class B foam concentrate.

3. The system of claim 1 wherein the additive is in the form of one of liquid, gas, powder, and solid.

4. The system of claim 1 wherein the water supply is one of an isolated water supply, a dedicated water supply, and a potable water supply.

5. The system of claim 1 wherein the water supply delivers water to the system at a pressure between about 7 pounds per square inch and about 500 pounds per square inch.

6. The system of claim 1 and further comprising an injection port downstream of the flowmeter and in fluid communication with the water line, the injection port providing additive from the additive supply tank, the injection port configured to withstand pressures up to about 125 pounds per square inch.

7. The system of claim 1 and further comprising a backflow preventer upstream of the flowmeter.

8. The system of claim 1 wherein the system delivers between about 0.01 gallons per minute and about 150 gallons per minute of additive from the additive supply tank.

9. The system of claim 1 wherein the system proportions water and additive within zero percent and about five percent of a value preset in the controller.

10. The system of claim 1 wherein the proportioner pump includes an electric motor, a positive displacement pump, and an electronic driver.

11. The system of claim 10 wherein the electric motor is a one-half horsepower motor.

12. The system of claim 10 wherein the positive displacement pump operates at up to about 2.5 gallons per minute and at up to about 150 pounds per square inch.

13. The system of claim 10 wherein the electric motor includes self-test capability.

14. The system of claim 10 wherein electronic driver receives signals from the controller to control the electric motor.

15. The system of claim 10 wherein the electronic driver uses one of a variable speed duty cycle and closed-loop direct current servo control to control the electric motor.

16. The system of claim 15 wherein the variable speed duty cycle provides pulse width modulation to facilitate low flow performance.

17. The system of claim 1 wherein the additive supply tank is positioned so that an outlet of the additive supply tank is higher than an inlet of the proportioner pump.

18. The system of claim 1 wherein the additive supply tank includes a level sensor.

19. The system of claim 18 wherein the level sensor provides a signal to the controller when about ten percent of the additive remains in the additive supply tank.

20. The system of claim 1 wherein the additive supply tank includes a site glass.

21. The system of claim 1 wherein at least a portion of the additive supply tank is constructed of a transparent material.

22. The system of claim 1 wherein the additive supply tank contains enough additive to allow the at least one sprinkler head to spray solution for about 20 minutes.

23. The system of claim 1 wherein a viscosity of the additive is less than about 100 centipoise.

24. The system of claim 1 wherein the controller includes a digital electronic display.

25. The system of claim 24 wherein the digital electronic display is coupled to the proportioner pump.

26. The system of claim 24 wherein the digital electronic display provides at least one of current flow-per-minute of water, total volume of water discharged during and after operations are complete, total amount of additive consumed, and total amount of additive remaining.

27. The system of claim 1 wherein the controller simulates flow rates for at least one of manual operation and remote testing.

28. The system of claim 1 wherein the controller performs setup, calibration, and diagnostic functions for installation and testing.

29. The system of claim 24 wherein the digital electronic display provides a warning when the additive supply tank is low.

30. The system of claim 24 wherein the digital electronic display provides a power fault warning when the system loses power.

31. The system of claim 24 wherein the digital electronic display provides a test fault warning when the system fails any self-diagnostic tests.

32. The system of claim 1 wherein the controller is connected to a network in order to be accessed remotely.

33. The system of claim 32 wherein at least one of additive level, additive flow rate, water flow rate, and current operating status can be accessed remotely.

34. The system of claim 1 wherein the flowmeter is a paddlewheel-type flowmeter.

35. The system of claim 1 wherein the flowmeter measures water flow over a range of about one feet per second to about 30 feet per second with an accuracy of about one percent.

36. The system of claim 1 and further comprising a second flowmeter to monitor solution flow rate.

37. The system of claim 1 wherein a maximum power used by the system is up to about 1200 Watts and up to about 10 amps in an active state and up to about 24 Watts and up to about 200 milliamps in a quiescent state.

38. The system of claim 1 and further comprising an uninterruptible power supply.

39. The system of claim 1 and further comprising a case configured to store at least one of the proportioner pump, the controller, and the additive supply tank.

40. The system of claim 39 wherein the case includes wheels to facilitate movement of the case into a structure.

41. The system of claim 1 wherein the system is configured for use in a structure including at least one of a residential building, a commercial building, an industrial building, a complex, and a high-rise.

42. The system of claim 1 wherein the at least one sprinkler head includes at least one of a water sprinkler head, a compressed gas sprinkler head, and a mist sprinkler head.

43. The system of claim 1 wherein the controller is connected to a fire panel communication system capable of reporting at least one of a status indicator, a warning, a fault condition, and a service date to a remote location.

44. The system of claim 43 wherein the fire panel communication system is connected to a remote location by at least one of a wired network, a wireless network, and a phone network.

45. The system of claim 43 wherein the remote location includes at least one of a security system company, a 911 dispatcher, a fire call box, and a monitoring company.

46. The system of claim 43 wherein the fire panel communication system provides historical data for the system to a remote location.

47. The system of claim 1 wherein the controller uses closed loop control to monitor and manage the system.

48. The system of claim 1 wherein the controller reads the flowmeter, calculates an amount of additive necessary for a desired proportioning rate, and adjusts a speed of the proportioner pump based on the amount of additive necessary.

49. The system of claim 1 and further comprising at least one gas tank to create compressed gas solution.

50. The system of claim 49 wherein compressed gas is used to drive additive into the water line.
